(19) United States
(12) Patent Application Publication
(10) Pub. No.: US 2025/0190559 A1
(43) Pub. Date: Jun. 12, 2025

(54) ORCHESTRATION SYSTEM CONTROL PLANE PROTECTION

(71) Applicant: Cisco Technology, Inc., San Jose, CA (US)

(72) Inventors: Thomas Szigeti, Vancouver (CA); Akram Sheriff, Newark, CA (US); Shannon K. McFarland, Parker, CO (US)

(21) Appl. No.: 18/536,869

(22) Filed: Dec. 12, 2023

(51) Int. Cl. G06F 21/56

(52) U.S. Cl. CPC G06F 21/56; G06F 2221/034

(57) ABSTRACT

Techniques for intelligently, dynamically, and proactively protecting orchestration system control planes and/or their application programming interface (API) servers against Denial of Service (DoS) and other abnormal events, whether intentional or unintentional. The techniques may include determining, based at least in part on metering requests to a control plane associated with an orchestration system for managing containerized microservices applications, a threshold request rate associated with invoking a policy action for preventing a denial-of-service (DoS) event. The techniques may also include determining that a rate in which the requests are received at the control plane meets or exceeds the threshold request rate. Based at least in part on the rate meeting or exceeding the threshold request rate, the policy action may be invoked to prevent the DoS event.

### TECHNICAL FIELD

The present disclosure relates generally to techniques for, among other things, intelligently, dynamically, and proactively protecting orchestration system control planes and/or their application programming interface (API) servers against Denial of Service (DoS) and other abnormal events, whether intentional or unintentional.

### BACKGROUND

In the context of orchestration systems for managing containerized microservices applications, the control planes of these orchestration systems are a critical component that is responsible for managing and maintaining the overall state of a cluster. For instance, the control plane may act as the brain of the cluster, overseeing and coordinating all activities within the system. While the control plane consists of several key components that each serve a specific purpose, application programming interface (API) servers typically are the central management point for the control plane as they expose the overall orchestration system API, which allows users and external systems to interact with the cluster. That is, all administrative tasks, OAM, and communication with the cluster occur through the API server as the API server is the primary interface to the orchestration system control plane.

However, a common infrastructure issue for orchestration systems is that the API server can become overloaded, resulting in excessive response times and/or timeouts. To mitigate this behavior, mechanisms to manage access to these API servers have been implemented natively within orchestration systems. For instance, Kubernetes has implemented a mechanism referred to as the “API Priority and Fairness (APF)” feature. However, this mechanism is quite basic and is oriented around prioritizing requests from different types of resources regardless of the nature of a request itself, nor the frequency of incoming requests, etc. As such, even with these basic mechanisms in place, an attacker could still cause a Denial-of-Service (DoS) attack on an entire cluster in a number of ways, not to mention the fact that DoS events can be triggered unintentionally, such as by a high-priority resource that is stuck in a loop and unable to proceed without a response from the control plane API server.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example architecture that may implement various aspects of the technologies disclosed herein for protecting orchestration systems from DoS and other adverse events.

FIG. 2 is a flow diagram illustrating an example method associated with the techniques described herein.

FIG. 3 is a flow diagram illustrating an example method associated with determining a threshold request rate in accordance with the techniques disclosed herein.

FIG. 4 is a flow diagram illustrating another example method associated with the techniques described herein.

FIG. 5 is a flow diagram illustrating yet another example method associated with the techniques described herein.

FIG. 6 is a computing system diagram illustrating an example configuration of a data center that can be utilized to implement aspects of the technologies disclosed herein.

FIG. 7 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes various technologies for intelligently, dynamically, and proactively protecting orchestration system control planes and/or their API servers against Denial of Service (DoS) and other abnormal events, whether intentional or unintentional. By way of example, and not limitation, the techniques described herein may include determining, based at least in part on metering requests to a control plane associated with an orchestration system for managing containerized microservices applications, a threshold request rate associated with invoking a policy action for preventing a denial-of-service (DoS) event. The techniques may also include determining that a rate (e.g., optimum rate) in which the requests are received at the control plane meets or exceeds the threshold request rate. Based at least in part on the rate meeting or exceeding the threshold request rate, the policy action may be invoked to prevent the DoS event.

Additionally, the techniques described herein may be performed as a method and/or by a system having non-transitory computer-readable media storing computer-executable instructions that, when executed by one or more processors, performs the techniques described above and herein.

### EXAMPLE EMBODIMENTS

As noted above, even with basic control plane/API server flow protection mechanisms in place, attackers can still cause DoS attacks on entire clusters in a number of ways. For instance, to cause DoS events, attackers can manipulate or forge various requests and/or updates, including, but not limited to, node health updates, node non-health updates, leader election requests, requests from built-in controllers, and/or requests from service accounts. Furthermore, to trigger a DoS event attackers can set or change the flow schema of a given flow to the highest priority level and then blast that flow at the API server. In addition, DoS events are not always intentional either, as DoS events can be triggered unintentionally, such as by a high-priority resource that is stuck in a loop and unable to proceed without a response from the control plane API server.

This application is directed to technologies for protecting orchestration system control planes and/or API servers from intentional or unintentional Denial-of-Service (DoS), Distributed-Denial-of-Service (DDoS), and/or other abnormal events. For example, based at least in part on metering requests to a control plane associated with an orchestration system for managing containerized microservices applications, a threshold request rate may be determined for invoking a policy action that prevents denial-of-service (DoS) events. In this way, if a current rate in which requests are received at the control plane and/or by the control plane API meets or exceeds the threshold request rate, various policy actions may be invoked to prevent the DoS event. As will become apparent in further detail below, the techniques disclosed herein can be implemented in a number of ways, each of which being capable of intelligently, dynamically, and proactively protecting orchestration system control planes and/or API servers. As used herein, the term “orchestration system” or “application orchestration system” means a system for managing containerized microservices applications, such as Kubernetes, Docker Swarm, Nomad, and/or other Container as a Service (CaaS) systems, managed Kubernetes Services, lightweight orchestrators, Platform as a Service (PaaS) systems, and/or the like.

In some examples, the techniques disclosed herein may implement a meter on the number of requests made to the orchestration system control plane and/or API server over time (e.g., requests per second (rps)). The meter may include a threshold that, if exceeded, can invoke a policy action. For example, the meter may be configured with default settings (e.g., industry general best practice guidelines), which may be manually overridden by an orchestration system administrator. This approach may offer a degree of protection, but may not be well suited to all environments. Additionally, this approach may place additional research and monitoring burdens on the orchestration system administrator to determine the optimal threshold. For instance, if the threshold is set too high, then the control plane may become unnecessarily exposed to DoS events. On the other hand, if the threshold is set too low; then legitimate API server requests may suffer unnecessarily.

In some examples, the meter may be self-configured (e.g., using machine-learning and/or other artificial intelligence (AI) techniques) based on a pre-determined learning period. For example, the meter may initially be enabled or otherwise implemented/provisioned as a “learning” model, during which the meter may baseline the requests-per-second of the orchestration system API server. After a pre-determined learning period (e.g., one week, two weeks, etc.), the meter may be capable of self-configuring the threshold at which to invoke policy action(s) or, in other words, detect the presence of a potential DoS event. As an example of this self-configuring, the meter may determine the standard deviation of requests per second and set a policy at 2 standard-deviations above the mean, which may statistically permit around 95% of normal traffic requests to pass without invoking any policy action.

In various examples, multiple different policy actions may also be implemented to make the meter more effective and adaptable to various business objectives. As a more basic example, the policy action could default to simply discard the excess requests. However, the trade-off to this approach is that legitimate requests may be randomly discarded in the process. In a more complex example, the system may discretely identify the resource(s) making the anomalous quantity of requests and discard those requests more aggressively, thereby allowing requests from other resources to continue unaffected. Additionally, the meter/system may send an alert to a Cloud Native Application Protection Platform (CNAPP) or other security platform informing it of this anomalous and potentially suspicious activity.

In yet another example, the policy action may be not to discard, but rather to treat excess requests with a “less-than-default” priority level (e.g., sometimes referred to as a “Scavenger” level of Quality of Service (QOS)). For instance, this can be achieved by configuring a dynamic flow control schema for the orchestration system API server with parameters that offer a lower-level of servicing than the default flow (e.g., the global-default priority level of queuing). Next, the policy may be enforced in two parts. The first part is the in-line meter with the (manually or auto-defined) threshold that, if exceeded, triggers the policy action: if exceeded, then the offending flow has its traffic re-assigned to the “less-than-default” priority level of API priority queuing, at which point it is handed off to the queuing policy. Next, the queuing policy may treat the excess request traffic with the lowest level of service, but may still be able to service it nonetheless: if however, the queues fill to capacity, then the excess traffic may simply be tail-dropped. In this scavenger-based queuing method for excess requests, every effort is made to service requests to the full resource limits available to the orchestration system API server, but intelligent protection is offered to the control plane and/or API server in the case of extreme circumstances and/or deliberate DoS attacks.

In some examples, the specific policy actions taken may also be dynamic and change on a case-by-case basis. For instance, excess traffic could be reassigned to a “less-than-default” priority level for a short period of time, and then if the excess rate of requests is sustained, the policy action could by dynamically changed to drop the excess traffic, treat the excess traffic with an even lower priority level for an additional period of time before being dropped, etc. This approach prevents the queuing system from filling unnecessarily and also limits the number of anomalous requests that the API server will eventually have to process before it becomes available again.

In some examples, the threshold-limits and/or policy actions may similarly be influenced by factors beyond the offered traffic rates. For example, if a CNAPP or other security platform is aware that a given pod or other resource contains software components with known vulnerabilities (e.g., making it more susceptible to compromise and being leveraged as part of a DoS attack), then the API server request limit threshold applied to it may be preemptively lowered and/or the policy action may be made more severe (e.g., immediately drop excess API server requests instead of reassigning these to a lower priority level). This results in a CNAPP-integrated, closed-loop approach to protecting orchestration system control planes and/or their API servers that was not previously possible absent the technologies disclosed herein.

By way of example, and not limitation, a method according to the techniques disclosed herein may include metering requests to a control plane and/or control plane API that is associated with an orchestration system for managing containerized microservices applications (e.g., Kubernetes, etc.). For instance, a system for carrying out some or all of the aspects described in this disclosure may be embedded or have elements and/or components co-located (e.g., in the same datacenter) with orchestration system resources. In this way, the system may be capable of establishing a meter to monitor the flows to the control plane and/or control plane API associated with the orchestration system. In examples, metering the requests to the control plane may include determining a rate at which request are received at the control plane over time, which may be calculated in requests per second (rps). Additionally, in some examples, metering the requests may include metering individual flows or resources that are making the requests, determining average numbers of requests for flows/resources communicating with the control plane, determining periods of time (e.g., days of the week, times of a day, etc.) when the rate of requests is least/greatest, or the like.

In some examples, the method may include determining a threshold request rate associated with invoking a policy action for preventing a DoS event. That is, a threshold request rate may be determined that is indicative of a problematic scenario, such as a DoS event in which the control plane and/or API server is flooded with a number of requests that is above what it would otherwise expect to receive under the same or similar circumstances (e.g., time of day, day of week, resources sending the requests, etc.). In some examples, the threshold request rate may be determined based at least in part on the metering described above and herein. In some examples, machine-learning and/or other AI techniques may be utilized to determine the threshold request rate. As an example, based at least in part on data gathered over a period of time during the metering stage, a mean rate at which requests are made to the control plane may be calculated or otherwise determined. Additionally, a standard deviation associated with the mean rate may be calculated, and the threshold request rate may be set based at least in part on the standard deviation value and the mean rate (e.g., threshold request rate set at two times the standard deviation value, at one and one-half times the mean rate, etc.). In this way, threshold request rates may be determined for orchestration system control planes/API servers on a per-system or per-cluster basis to meet the requirements/expectations of specific systems and their resources.

In some examples, the threshold request rate may be set on a total flow basis and/or on an individual flow basis. For instance, if the threshold request rate is acting on a total flow basis, the threshold may be exceeded if a total number of requests to the control plane/API server exceeds the threshold. Additionally, or alternatively, if the threshold request rate is acting on an individual or per-flow basis (e.g., “per-flow threshold request rate”), the threshold may be exceeded if a number of requests received from an individual flow/resource exceeds the threshold. In such scenarios, it may be possible for a per-flow threshold request rate to be exceeded even though a total threshold request rate is not exceeded. This allows flexibility of the system to invoke policy actions for potentially problematic flows prior to DoS events occurring. In some examples, the system may be configured to first determine if the total threshold request rate is exceeded before determining whether any per-flow threshold request rates are exceeded. In this way, intermediate policy actions may be taken while the system identifies the root of the problem and before the system invokes more stringent policy actions. Additionally, or alternatively, the system may be configured to monitor all of the threshold rates simultaneously and invoke specific policy actions when any individual threshold is exceeded.

In some examples, the method may also include determining that a rate in which the requests are received at the control plane meets or exceeds the threshold request rate and/or per-flow threshold request rate. For instance, after determining the threshold request rate(s), the system may continue to meter/monitor the requests made to the control plane/API server to determine if the threshold request rate and/or per-flow threshold request rate is/are exceeded.

In examples, based at least in part on the rate meeting or exceeding the threshold request rate and/or per-flow threshold request rate, a policy action may be determined for preventing a DoS event or other adverse event. In some examples, the policy action may be determined or otherwise selected on a case-by-case basis, and different policy actions may be invoked under different circumstances. For instance, in some examples the policy action may simply be to drop a portion of the requests to the control plane that are in excess of the threshold request rate. However, such a simplistic and unselective policy action may result in legitimate requests being dropped along with any potentially malicious/problematic requests.

In some examples, the policy action may include identifying a specific flow/resource that is generating a portion of the requests to the control plane in excess of the per-flow threshold request rate and then applying the policy action or another policy action to the portion of the requests generated by that flow/resource while refraining from applying the policy action(s) to other requests generated by other flows (e.g., legitimate flows/requests).

In some examples, the system may apply an initial policy action to a specific, problematic flow for a period of time, and then re-evaluate the flow after an expiration of the period of time. For instance, when the system first identifies that the flow is potentially problematic (e.g., exceeding per-flow threshold, generating more requests than usual, generating more requests relative to other resources/flows, etc.), the system may apply a first policy, such as queuing the requests or treating the request with a “less-than-default” priority level. The system may then continue to meter/monitor the flow for the period of time to determine whether the number of requests improves, stays the same, worsens, or otherwise fails to reduce below the threshold request rate and/or a per-flow threshold request rate, etc. Then, at the expiration of the period of time, the system may choose to remove the policy (e.g., the number of requests improved/lessened), keep the policy in place (e.g., the number of requests stayed the same), or apply a new, potentially more stringent policy, such as dropping the requests received from that flow/resource completely (e.g., if the number of requests stayed the same or worsened). This is just yet another example of the adaptable and dynamic policy enforcement the technologies disclosed herein are capable of implementing to help avoid DoS, DDoS, and other adverse events.

In some examples, the various policy actions that the system may invoke can include, but not be limited to, dropping excess requests as a whole and/or on a per-flow basis, queuing excess requests as a whole and/or on a per-flow basis, treating excess requests with lower priority as a whole and/or on a per-flow basis, alerting a security platform (e.g., CNAPP) of a problematic flow or DoS event), and/or labeling a flow as problematic/compromised. In some examples, the system may be capable of identifying containerized applications with known vulnerabilities, and in such cases the system may be more strict in its application of policy in order to keep that application running.

As will be understood by those having skill in the art, the techniques of this disclosure can be implemented in a number of different ways to enforce or otherwise initiate a policy framework to prevent a DoS event. In examples, the policy framework can include any number or combination of the various policy actions and measures described herein to mitigate the effect of a potentially problematic flow on the system as a whole. For instance, as noted above, the techniques may include determining a threshold request rate associated with invoking a policy framework for preventing a DoS event. Once this threshold is determined, if the threshold is exceeded, the policy framework may begin to be applied. However, the policy framework can be different based on the organization and/or based on the specific set of circumstances observed that triggered the policy framework. In some examples, the policy framework may include, among other things, identifying a flow that is generating a portion of the requests to the control plane in excess of a per-flow threshold request rate, applying a first policy action to the portion of the requests generated by the flow while refraining from applying the policy action to other requests generated by other flows, determining, at an expiration of a period of time associated with applying the first policy action, whether the portion of the requests generated by the flow has reduced below the per-flow threshold request rate, and either one of applying a second policy action based at least in part on the portion of the requests generated by the flow failing to reduce below the per-flow threshold request rate, or discontinuing application of the first policy action based at least in part on the portion of the requests generated by the flow reducing below the per-flow threshold request rate.

According to the techniques disclosed herein, several advantages in computer-related technology can be realized. For instance, by identifying problematic flows and isolating them from other, legitimate flows, the techniques help avoid DoS and other adverse events from compromising containerized applications running on orchestration system platforms. Additionally, the techniques disclosed herein allow for normal traffic requests to pass through without invoking a policy action, while restricting abnormal traffic requests, thereby maintaining normal operation of cloud-native applications while offering protection from DoS attackers. In other words, when an attacker would previously try to compromise an orchestration system by causing a DoS event, the whole orchestration system would likely be compromised, but by implementing the techniques disclosed herein, these DoS events can be avoided completely. Additionally, by being able to dynamically change priority levels for certain request received from certain flows, QoS can be built into the control plane/API server to treat normal flows with higher priority so they do not unnecessarily suffer because of an attacker or abnormal flow. These and other advantages in computer-related technology will be readily apparent to those having ordinary skill in the art.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

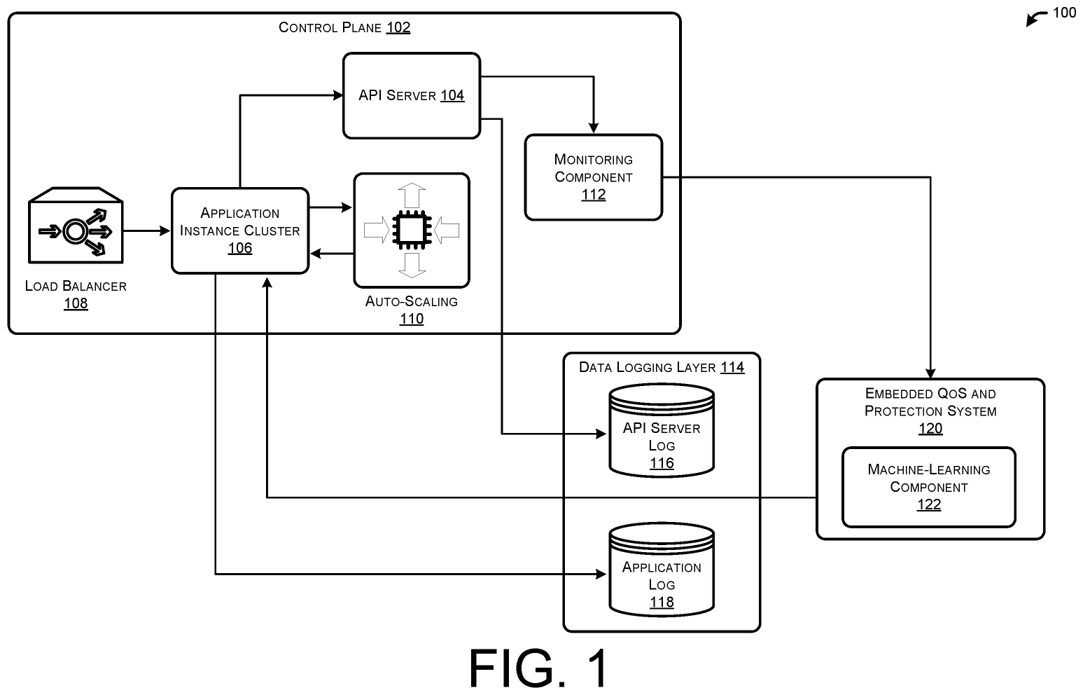

FIG. 1 illustrates an example architecture 100 that may implement various aspects of the technologies disclosed herein for protecting orchestration systems from DoS and other adverse events. In examples, the architecture 100 may represent a portion of an orchestration system for hosting cloud-delivered applications, such as containerized microservices applications. In some instance, some or all of the architecture 100 may be located in a same data center or other network computer environment. The architecture 100 includes a control plane 102 which may be associated with an orchestration system for running containerized microservices applications. The control plane 102 includes an API server 104. The API server 104 may act as the front-end for the control plane 102 and expose the orchestration system's API, which users, other components, and external entities may interact with to manage the cluster (e.g., application instance cluster 106). The API server 104 may also validate and process requests received from connected users, resources, flows, etc. The control plane 102 may also include an application load balancer 108, an auto-scaling component 110, and a monitoring component 112.

In some examples, the monitoring component 112 may implement the meter as described above and herein in accordance with the disclosed techniques. For instance, the monitoring component 112 may monitor the requests received at the control plane 102 and/or API server 104, and actively determine whether threshold request rate(s) are exceeded.

The architecture 100 may also include a data logging layer 114. The data logging layer 114 may include an API server log 116 and an application log 118. In examples, the API server log 116 may store logs and historical data associated with the API server 104. In some instances, these logs may include information regarding usage, historical request rates, resources to which the API server 104 has communicated with, flows, and the like. Additionally, the logs stored in the API server log 116 may include information regarding previous DoS events, information about when the API server 104 is most constrained, least constrained, and/or the like. Similarly, the application log 118 may store information and historical data associated with the application instance cluster 106. Such information and historical data may include a list of applications which have previously experienced errors, application resource usage, when certain applications experience increased demand, and the like.

The architecture 100 may also include the embedded QoS (Quality of Service) and protection system 120, in accordance with the technologies disclosed herein. In examples, while the monitoring component 112 is shown within the control plane, the monitoring component 112 may be associated with the embedded QoS and protection system 120. That is, the embedded QoS and protection system 120 may receive indications and/or updates from the monitoring component 112 (e.g., as its agent) and decide which policies to invoke on a case-by-case basis, taking into account all of the information the embedded QoS and protection system 120 has available to it. For instance, the embedded QoS and protection system 120 may utilize a machine-learning component 122 to determine which policy actions to take. That is, the embedded QoS and protection system 120 may receive data from the monitoring component and input that data into a machine-learned model or other AI model to determine which policy actions to take. In some examples, the monitoring component 112 may also utilize the machine-learning component 122 and/or any machine-learned models therein to determine how to set the threshold request rate values, when to invoke policy actions, and/or the like.

In some examples, the embedded QoS and protection system 120 and/or the machine-learning component 122 may train the machine learned models that are to be used for policy determination as well as when to trigger policy actions. For instance, the embedded QoS and protection system 120 may be embedded into the architecture 100 for a learning period (e.g., 1 week, 2 weeks, etc.) to gather information about the control plane 102 and API server 104, as well as to train the models. In some examples, the embedded QoS and protection system 120 and/or the machine-learning component 122 may utilize data from the API server log 116 and/or the application log 118 to train the models. Additionally, the machine-learned models may be trained and/or refined while the embedded QoS and protection system 120 is actively monitoring the control plane 102 and invoking policy actions to deter DoS events. In this way, the models can be continuously trained and developed as circumstances change, as the system changes, as the application system scales, as DoS attackers become more advanced, and/or the like.

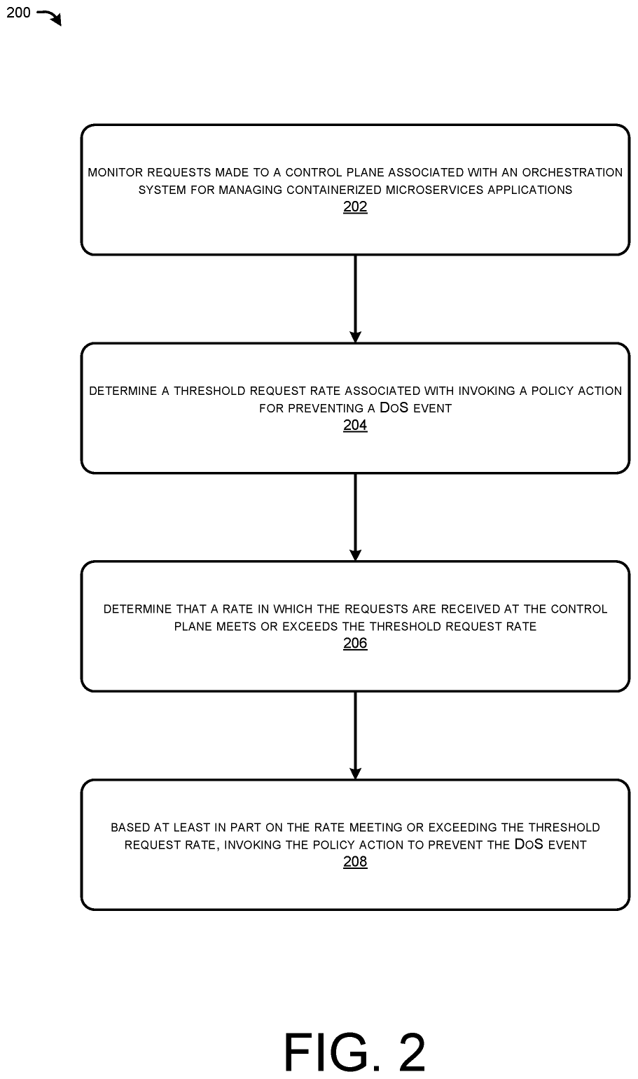

FIGS. 2-5 are flow diagrams illustrating various example methods in accordance with the techniques described herein. The logical operations described herein with respect to FIGS. 2-5 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIGS. 2-5 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 2 is a flow diagram illustrating an example method 200 associated with the techniques described herein. The method 200 begins at operation 202, which includes monitoring requests made to a control plane associated with an orchestration system for managing containerized microservices applications. For instance, the embedded QoS and protection system 120 and/or the monitoring component 112 may monitor the requests made to the control plane 102. In some examples, the monitoring in operation 202 may be during an initial learning period, or may be during a period in which the embedded QoS and protection system 120 is actively monitoring the control plane 102 and taking proactive measurements and applying policies to discourage DoS events.

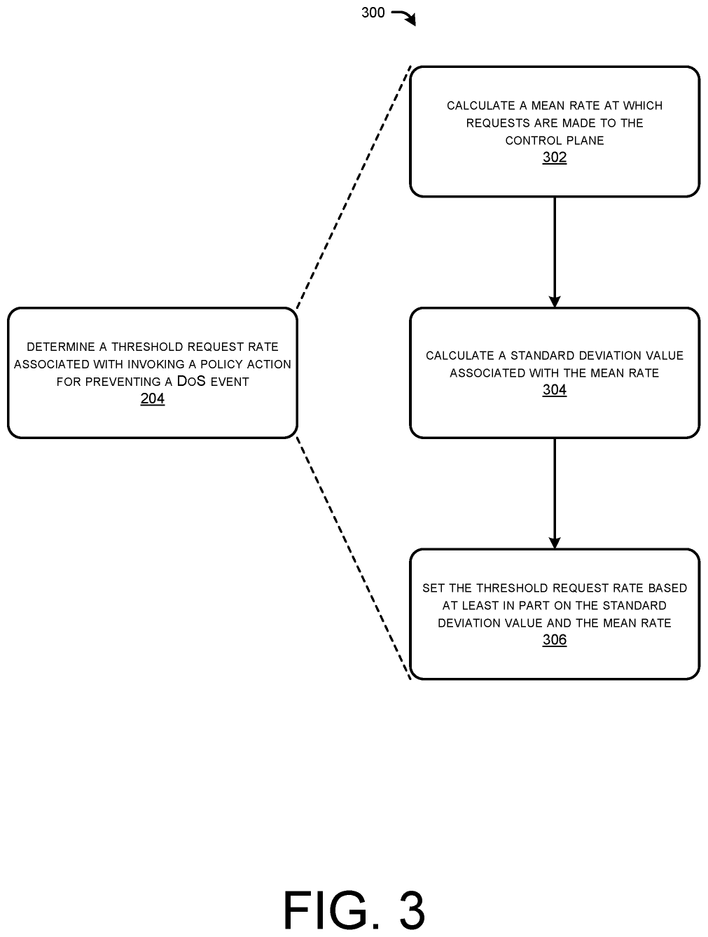

At operation 204, the method 200 includes determining a threshold request rate associated with invoking a policy action for preventing a DoS event. For instance, the embedded QoS and protection system 120 may determine the threshold request rate associated with invoking the policy action. In some instances, the embedded QoS and protection system 120 may utilize the machine-learning component 122 to determine the threshold request rate. In some instances, the monitoring component 112 may determine the threshold request rate. Similarly, in some instances, the monitoring component may utilize the machine-learning component 122 to determine the threshold request rate. Further detail about determining the threshold request rate will be further described below in FIG. 3.

At operation 206, the method 200 includes determining that a rate in which the requests are received at the control plane meets or exceeds the threshold request rate. For instance, the monitoring component 112 of the embedded QoS and protection system 120 may determine that the rate in which the requests are received at the control plane 102 and/or API server 104 meets or exceeds the threshold request rate.

At operation 208, the method 200 includes based at least in part on the rate meeting or exceeding the threshold request rate, invoking the policy action to prevent the DoS event. For instance, the embedded QoS and protection system 120 may invoke the policy action to prevent the DoS event. In some instances, the embedded QoS and protection system 120 may utilize the machine-learning component 122 and/or any machine-learned models therein to select a proper policy action based on the given circumstances, rather than selecting a generic policy action to be applied that could be detrimental to legitimate requests being received from non-problematic flows.

FIG. 3 is a flow diagram illustrating an example method 300 associated with determining a threshold request rate in accordance with the techniques disclosed herein (e.g., operation 204 of FIG. 2). The method 300 begins at operation 302, which includes calculating a mean rate at which the requests are made to the control plane. For instance, the embedded QoS and protection system 120 and/or the monitoring component 112 may calculate the mean rate at which the requests are made to the control plane 102 and/or received by the API server 104. In some examples, the mean rate may be calculated based on information gathered over a learning period.

At operation 304, the method 300 includes calculating a standard deviation value associated with the mean rate. For instance, based at least in part on calculating the mean rate, the embedded QoS and protection system 120 and/or the monitoring component 112 may also calculate the standard deviation of the mean rate utilizing the information gathered during the learning period.

At operation 306, the method 300 includes setting the threshold request rate based at least in part on the standard deviation value and the mean rate. For instance, the embedded QoS and protection system 120 and/or the monitoring component 112 may set the threshold request rate based at least in part on the standard deviation and the mean rate (e.g., may be set at two times the standard deviation, at one and one-half times the mean, a combination thereof, or the like).

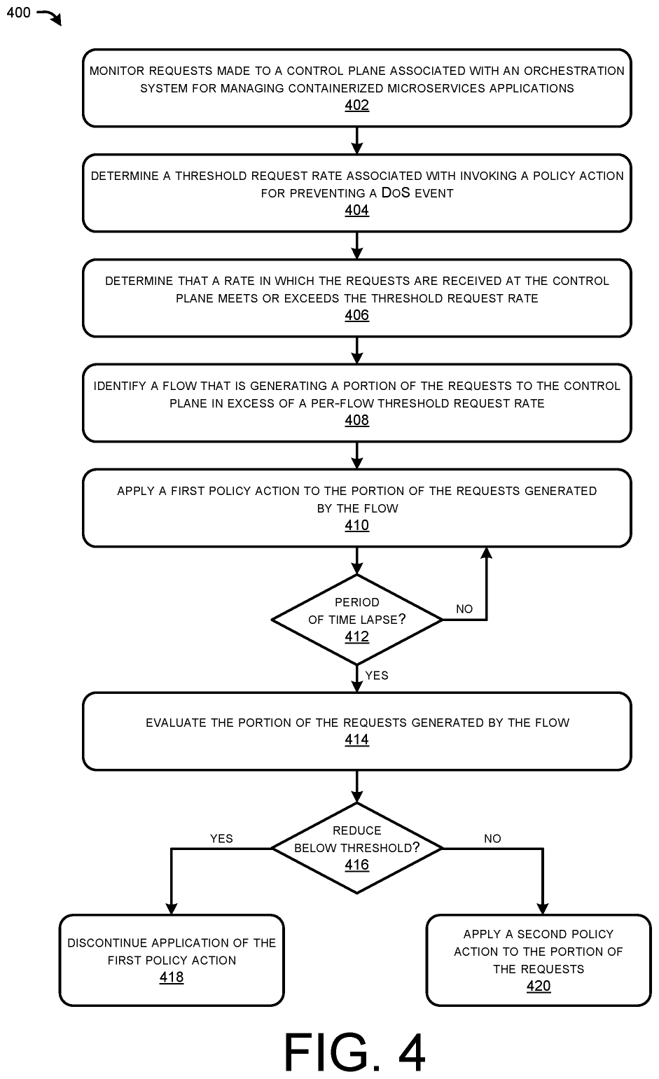

FIG. 4 is a flow diagram illustrating another example method 400 associated with the techniques described herein. The method 400 begins at operation 402, which includes monitoring requests made to a control plane associated with an orchestration system for managing containerized microservices applications. For instance, the embedded QoS and protection system 120 and/or the monitoring component 112 may monitor the requests made to the control plane 102. In some examples, the monitoring in operation 402 may be during an initial learning period, or may be during a period in which the embedded QoS and protection system 120 is actively monitoring the control plane 102 and taking proactive measurements to discourage DoS events.

At operation 404, the method 400 includes determining a threshold request rate associated with invoking a policy action for preventing a DoS event. For instance, the embedded QoS and protection system 120 may determine the threshold request rate associated with invoking the policy action. In some instances, the embedded QoS and protection system 120 may utilize the machine-learning component 122 to determine the threshold request rate. In some instances, the monitoring component 112 may determine the threshold request rate. Similarly, in some instances, the monitoring component may utilize the machine-learning component 122 to determine the threshold request rate. In some examples, the method 300 described in FIG. 3 may be utilized to determine the threshold request rate.

At operation 406, the method 400 includes determining that a rate in which the requests are received at the control plane meets or exceeds the threshold request rate. For instance, the monitoring component 112 of the embedded QoS and protection system 120 may determine that the rate in which the requests are received at the control plane 102 and/or API server 104 meets or exceeds the threshold request rate.

At operation 408, the method 400 includes identifying a flow that is generating a portion of the requests to the control plane in excess of a per-flow threshold request rate. For instance, the embedded QoS and protection system 120 and/or the monitoring component 112 may identify the flow that is generating the portion of the requests to the control plane in excess of the per-flow threshold request rate. In other words, the embedded QoS and protection system 120 and/or the monitoring component 112 may identify a potentially problematic flow that is flooding the control plane and/or API server with an unreasonable number of requests that could potentially lead to a DoS event.

At operation 410, the method 400 includes applying a first policy action to the portion of the requests generated by the flow. For instance, the embedded QoS and protection system 120 may apply the first policy action to the portion of the requests generated by the flow to prevent the DoS event. In some instances, the embedded QoS and protection system 120 may utilize the machine-learning component 122 and/or any machine-learned models therein to select a proper first policy action based on the given circumstances, rather than selecting a generic policy action to be applied that could be detrimental to legitimate requests being received from non-problematic flows.

At operation 412, the method 400 includes determining whether a period of time has lapsed, the period of time associated with the application of the first policy action. If the period of time has not elapsed, then the method 400 proceeds back to operation 410 to continue applying the first policy action and monitoring the control plane/API server. However, if the period of time has lapsed, then the method 400 proceeds to operation 414. In some examples, the period of time may be any duration of time, such as one minute, ten minutes, sixty minutes, etc.

At operation 414, the method 400 includes evaluating the portion of the requests generated by the flow. For instance, after the expiration of the period of time, the embedded QoS and protection system 120 and/or the monitoring component 112 may re-evaluate the portion of the requests generated by the flow to determine whether the number of requests per second has decreased below the threshold, maintained its rate, or increased.

At operation 416, the method 400 includes determining, based on the evaluating, whether the current rate of requests received from the flow has reduced below the per-flow threshold request rate. If the rate has reduced, then the method 400 proceeds to operation 418. However, if the rate has failed to reduce below the threshold (e.g., remained the same, increased, etc.), then the method 400 may proceed to operation 420.

At operation 418, the method 400 includes discontinuing application of the first policy action. For instance, based on the request rate reducing below the threshold, the embedded QoS and protection system 120 may remove the first policy action from being applied to the requests from that flow. In other words, the system may resume normal operation on at least these flows, if not all of the flows as a whole.

At operation 420, the method 400 includes applying a second policy action to the portion of the requests. For instance, based on the rate either increasing or remaining the same, the embedded QoS and protection system 120 may invoke a second policy action to the portion of the requests generated by the problematic flow: Such a second policy action could be more severe than the first policy action, in some examples (e.g., completely drop the requests without evaluating). Additionally, or alternatively, the second policy action could be more tailored to the flow than the first policy action (e.g., determine flow is legitimate so start queueing requests or treating some with lower priority).

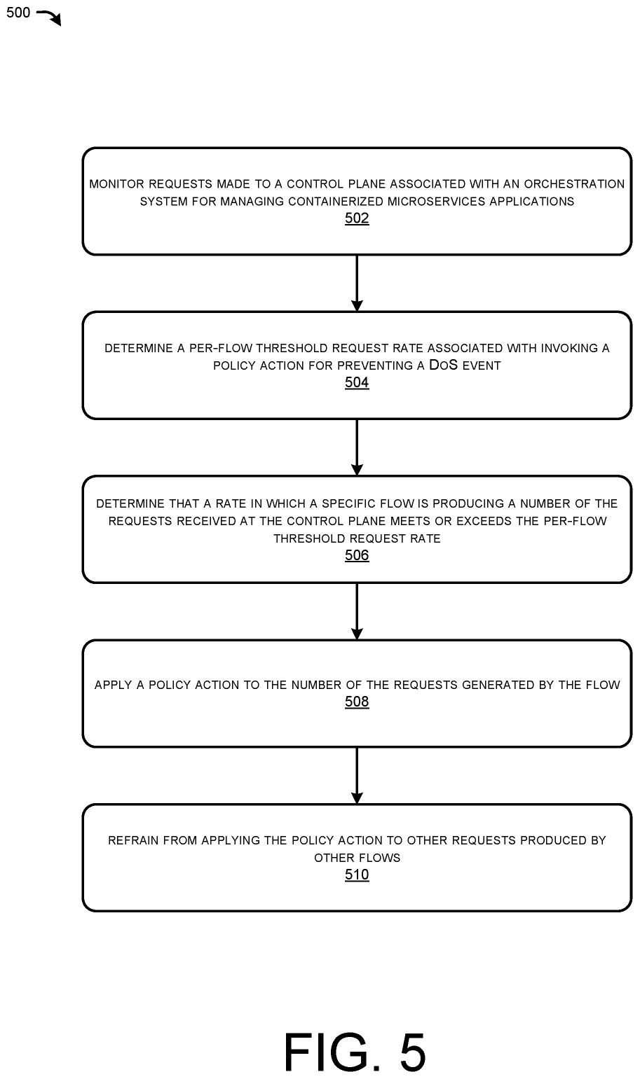

FIG. 5 is a flow diagram illustrating yet another example method 500 associated with the techniques described herein. The method 500 begins at operation 502, which includes monitoring requests made to a control plane associated with an orchestration system for managing containerized microservices applications. For instance, the embedded QoS and protection system 120 and/or the monitoring component 112 may monitor the requests made to the control plane 102. In some examples, the monitoring in operation 502 may be during an initial learning period, or may be during a period in which the embedded QoS and protection system 120 is actively monitoring the control plane 102 and taking proactive measurements and making policy decisions to discourage DoS events.

At operation 504, the method 500 includes determining a per-flow threshold request rate associated with invoking a policy action for preventing a DoS event. For instance, the embedded QoS and protection system 120 may determine the per-flow threshold request rate associated with invoking the policy action. In some instances, the embedded QoS and protection system 120 may utilize the machine-learning component 122 to determine the per-flow threshold request rate. In some instances, the monitoring component 112 may determine the per-flow threshold request rate. Similarly, in some instances, the monitoring component may utilize the machine-learning component 122 to determine the per-flow threshold request rate.

At operation 506, the method 500 includes determining that a rate in which a specific flow is producing a number of the requests received at the control plane meets or exceeds the per-flow threshold request rate. For instance, the monitoring component 112 of the embedded QoS and protection system 120 may determine that the rate in which the specific flow is producing the number of the requests received at the control plane 102 and/or API server 104 meets or exceeds the per-flow threshold request rate.

At operation 508, the method 500 includes applying a policy action to the number of the requests generated by the flow to prevent the DoS event. For instance, the embedded QoS and protection system 120 may apply the policy action to the number of the requests generated by the flow to prevent the DoS event. In some instances, the embedded QoS and protection system 120 may utilize the machine-learning component 122 and/or any machine-learned models therein to select a proper policy action based on the given circumstances, rather than selecting a generic policy action to be applied that could be detrimental to legitimate requests being received from non-problematic flows.

At operation 510, the method 500 includes refraining from applying the policy action to other requests produced by other flows. For instance, the embedded QoS and protection system 120 may refrain from applying the policy action to the other requests produced by the other flows (e.g., the non-problematic flows) so that legitimate requests are still received and/or processed by the API server 104.

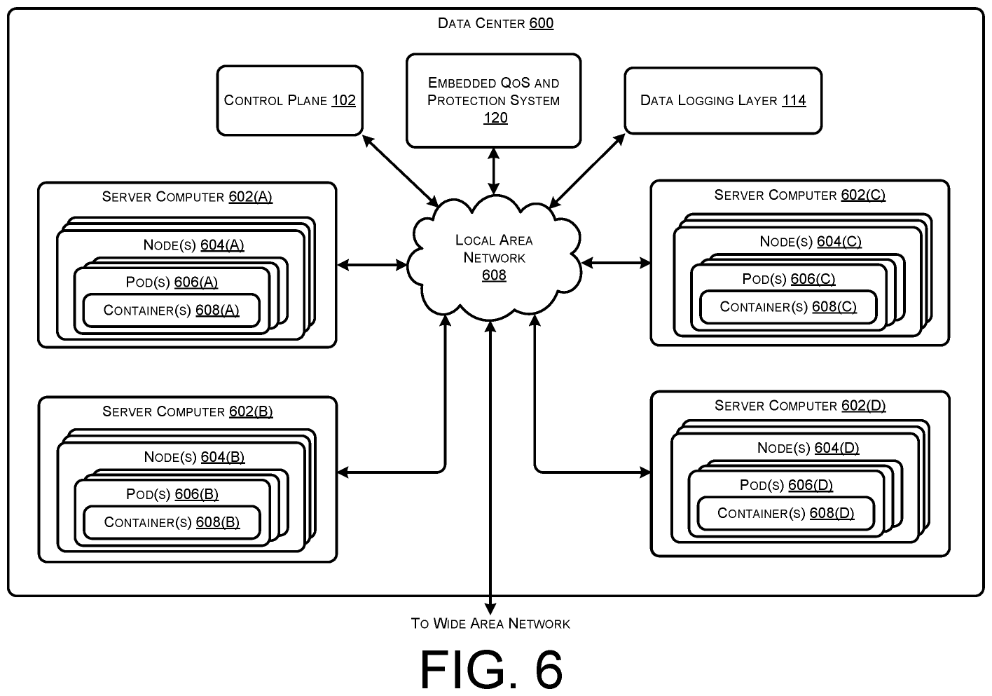

FIG. 6 is a computing system diagram illustrating an example configuration of a data center 600 that can be utilized to implement aspects of the technologies disclosed herein. The example data center 600 shown in FIG. 6 includes several server computers 602A-602D (which might be referred to herein singularly as “a server computer 602” or in the plural as “the server computers 602”) for providing computing resources. In some examples, the resources and/or server computers 602 may include, or correspond to, the any type of networked device described herein. Although described as servers, the server computers 602 may comprise any type of networked device, such as servers, switches, routers, hubs, bridges, gateways, modems, repeaters, access points, proxies, etc. In some examples, one or more of the server computers 602 may host or otherwise support the orchestration system, the control plane 102, the data logging layer 114, and/or the embedded QoS and protection system 120.

The server computers 602 can be standard tower, rack-mount, or blade server computers configured appropriately for providing computing resources. In some examples, the server computers 602 may provide computing resources including data processing resources such as VM instances or hardware computing systems, database clusters, computing clusters, storage clusters, data storage resources, database resources, networking resources, VPNs, and others. Some of the servers 602 can also be configured to execute a resource manager capable of instantiating and/or managing the computing resources. In the case of VM instances, for example, the resource manager can be a hypervisor or another type of program configured to enable the execution of multiple VM instances on a single server computer 602. Server computers 602 in the data center 600 can also be configured to provide network services and other types of services.

In various examples, the server computers 602 may include infrastructure or otherwise be configured to host containerized microservices applications. For instance, the server computers 602 may include one or more node(s) 604A-604D, which may include one or more pod(s) 606A-606D for running one or more container(s) 608A-608D.

In the example data center 600 shown in FIG. 6, an appropriate LAN 608 (local area network) is also utilized to interconnect the server computers 602A-602D, the control plane 102, the data logging layer 114, and the embedded QoS and protection system 120. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers, between each of the server computers 602A-602D in each data center 600, and, potentially, between computing resources in each of the server computers 602. It should be appreciated that the configuration of the data center 600 described with reference to FIG. 6 is merely illustrative and that other implementations can be utilized.

In some instances, the data center 600 may provide computing resources, like tenant containers, VM instances, VPN instances, and storage, on a permanent or an as-needed basis. Among other types of functionality, the computing resources provided by a cloud computing network may be utilized to implement the various services and techniques described above. The computing resources provided by the cloud computing network can include various types of computing resources, such as data processing resources like tenant containers and VM instances, data storage resources, networking resources, data communication resources, network services, VPN instances, and the like.

Each type of computing resource provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources not mentioned specifically herein.

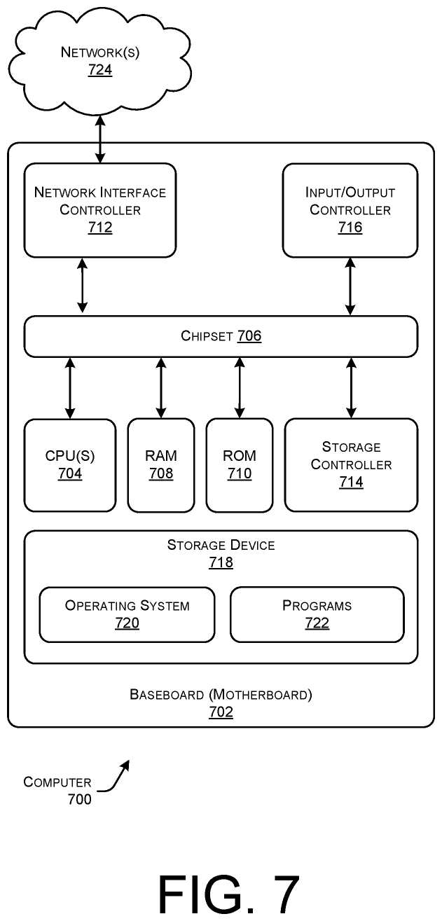

The computing resources provided by a cloud computing network may be enabled in one embodiment by one or more data centers 600 (which might be referred to herein singularly as “a data center 600” or in the plural as “the data centers 600”). The data centers 600 are facilities utilized to house and operate computer systems and associated components. The data centers 600 typically include redundant and backup power, communications, cooling, and security systems. The data centers 600 can also be located in geographically disparate locations. One illustrative embodiment for a data center 600 that can be utilized to implement the technologies disclosed herein will be described below with regard to FIG. 7.

FIG. 7 is a computer architecture diagram showing an illustrative computer hardware architecture for implementing a computing device that can be utilized to implement aspects of the various technologies presented herein. The computer architecture shown in FIG. 7 may be illustrative of a conventional server computer, router, switch, node, workstation, desktop computer, laptop, tablet, network appliance, e-reader, smartphone, load balancer, or other computing device, and can be utilized to execute any of the software components presented herein.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the computer 700. The chipset 706 can further provide an interface to a computer-readable storage medium such as a read-only memory (“ROM”) 710 or non-volatile RAM (“NVRAM”) for storing basic routines that help to startup the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network. The chipset 706 can include functionality for providing network connectivity through a NIC 712, such as a gigabit Ethernet adapter. The NIC 712 is capable of connecting the computer 700 to other computing devices over the network 724. It should be appreciated that multiple NICs 712 can be present in the computer 700, connecting the computer to other types of networks and remote computer systems. In some examples, the NIC 712 may be configured to perform at least some of the techniques described herein.

The computer 700 can be connected to a storage device 718 that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 700 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 718 by detecting the physical states or characteristics of one or more particular locations within the physical storage units.

In addition to the mass storage device 718 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by the architecture 100 and or any components included therein, may be supported by one or more devices similar to computer 700. Stated otherwise, some or all of the operations performed by the architecture 100 and or any components included therein, may be performed by one or more computer devices, which may be similar to the computer 700, operating in a scalable arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes and functionality described above with regard to FIGS. 1-6, and herein. The computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

The computer 700 may include one or more hardware processors (processors) configured to execute one or more stored instructions. The processor(s) may comprise one or more cores. Further, the computer 700 may include one or more network interfaces configured to provide communications between the computer 700 and other devices. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 722 may comprise any type of programs or processes to perform the techniques described in this disclosure for intelligently, dynamically, and proactively protecting orchestration system control planes and/or their API servers against DoS and other abnormal events, whether intentional or unintentional.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
determining, based at least in part on metering requests to a control plane associated with an orchestration system for managing containerized microservices applications, a threshold request rate associated with invoking a policy action for preventing a denial-of-service (DoS) event:
determining that a rate in which the requests are received at the control plane meets or exceeds the threshold request rate; and
based at least in part on the rate meeting or exceeding the threshold request rate, invoking the policy action to prevent the DoS event.

2. The method of claim 1, wherein determining the threshold request rate comprises:
calculating, based at least in part on the metering, a mean rate at which the requests are made to the control plane:
calculating a standard deviation value associated with the mean rate; and
setting the threshold request rate based at least in part on the standard deviation value and the mean rate.

3. The method of claim 1, wherein the threshold request rate is determined at least partially using machine-learning techniques and monitoring the requests to the control plane over a period of time.

4. The method of claim 1, wherein the policy action comprises dropping a portion of the requests to the control plane that are in excess of the threshold request rate.

5. The method of claim 1, wherein the policy action comprises:
identifying a flow that is generating a portion of the requests to the control plane in excess of a per-flow threshold request rate; and
applying the policy action to the portion of the requests generated by the flow while refraining from applying the policy action to other requests generated by other flows.

6. The method of claim 5, wherein the policy action is a first policy action that is applied to the portion of the requests for a period of time, the method further comprising:
determining, at an expiration of the period of time, whether the portion of the requests generated by the flow has reduced below the per-flow threshold request rate; and
either one of:
invoking a second policy action based at least in part on the portion of the requests generated by the flow failing to reduce below the per-flow threshold request rate; or
discontinuing the first policy action based at least in part on the portion of the requests generated by the flow reducing below the per-flow threshold request rate.

7. The method of claim 1, wherein the policy action comprises assigning a portion of the requests to the control plane that are in excess of the threshold request rate to be treated with a priority level that is less than a default priority level for servicing control plane requests.

8. The method of claim 1, wherein the policy action comprises:
identifying a flow that is generating a portion of the requests to the control plane in excess of a per-flow threshold request rate; and
assigning the portion of the requests generated by the flow to be treated with a priority level that is less than a default priority level for servicing control plane requests.

9. The method of claim 1, wherein the policy action comprises:
identifying, as an abnormal flow, a flow that is generating a portion of the requests to the control plane in excess of a per-flow threshold request rate; and
sending, to a security platform associated with the orchestration system, an indication of the abnormal flow.

10. A system comprising:
one or more processors; and
one or more non-transitory computer-readable media storing instructions that, when executed, cause the one or more processors to perform operations comprising:
determining, based at least in part on metering requests to a control plane associated with an orchestration system for managing containerized microservices applications, a threshold request rate associated with invoking a policy action for preventing a denial-of-service (DoS) event:
determining that a rate in which the requests are received at the control plane meets or exceeds the threshold request rate; and
based at least in part on the rate meeting or exceeding the threshold request rate, invoking the policy action to prevent the DoS event.

11. The system of claim 10, wherein determining the threshold request rate comprises:
calculating, based at least in part on the metering, a mean rate at which the requests are made to the control plane;
calculating a standard deviation value associated with the mean rate; and
setting the threshold request rate based at least in part on the standard deviation value and the mean rate.

12. The system of claim 10, wherein the threshold request rate is determined at least partially using machine-learning techniques and monitoring the requests to the control plane over a period of time.

13. The system of claim 10, wherein the policy action comprises dropping a portion of the requests to the control plane that are in excess of the threshold request rate.

14. The system of claim 10, wherein the policy action comprises:
identifying a flow that is generating a portion of the requests to the control plane in excess of a per-flow threshold request rate; and
applying the policy action to the portion of the requests generated by the flow while refraining from applying the policy action to other requests generated by other flows.

15. The system of claim 14, wherein the policy action is a first policy action that is applied to the portion of the requests for a period of time, the operations further comprising:
determining, at an expiration of the period of time, whether the portion of the requests generated by the flow has reduced below the per-flow threshold request rate; and
either one of:
invoking a second policy action based at least in part on the portion of the requests generated by the flow failing to reduce below the per-flow threshold request rate; or
discontinuing the first policy action based at least in part on the portion of the requests generated by the flow reducing below the per-flow threshold request rate.

16. The system of claim 10, wherein the policy action comprises assigning a portion of the requests to the control plane that are in excess of the threshold request rate to be treated with a priority level that is less than a default priority level for servicing control plane requests.

17. The system of claim 10, wherein the policy action comprises:
identifying a flow that is generating a portion of the requests to the control plane in excess of a per-flow threshold request rate; and
assigning the portion of the requests generated by the flow to be treated with a priority level that is less than a default priority level for servicing control plane requests.

18. The system of claim 10, wherein the policy action comprises:
identifying, as an abnormal flow, a flow that is generating a portion of the requests to the control plane in excess of a per-flow threshold request rate; and
sending, to a security platform associated with the orchestration system, an indication of the abnormal flow.

19. One or more non-transitory computer-readable media storing instructions that, when executed, cause one or more processors to perform operations comprising:
determining, based at least in part on metering requests to a control plane associated with an orchestration system for managing containerized microservices applications, a threshold request rate associated with invoking a policy framework for preventing a denial-of-service (DoS) event:
determining that a rate in which the requests are received at the control plane meets or exceeds the threshold request rate; and
based at least in part on the rate meeting or exceeding the threshold request rate, invoking the policy framework to prevent the DoS event, the policy framework including one or more policy actions to be taken to prevent the DoS event.

20. The one or more non-transitory computer-readable media of claim 19, wherein the policy framework comprises:
identifying a flow that is generating a portion of the requests to the control plane in excess of a per-flow threshold request rate:
applying a first policy action to the portion of the requests generated by the flow while refraining from applying the policy action to other requests generated by other flows:
determining, at an expiration of a period of time associated with applying the first policy action, whether the portion of the requests generated by the flow has reduced below the per-flow threshold request rate; and
either one of:
applying a second policy action based at least in part on the portion of the requests generated by the flow failing to reduce below the per-flow threshold request rate; or
discontinuing application of the first policy action based at least in part on the portion of the requests generated by the flow reducing below the per-flow threshold request rate.
